(19) United States
(12) Patent Application Publication
(10) Pub. No.: US 2008/0176056 A1
(43) Pub. Date: Jul. 24, 2008

(54) Composite Ceramic Hollow Fibers, Method for Their Production and Their Use

(76) Inventors: Mirjam Kilgus, Glatten (DE); Thomas Schiestel, Stuttgart (DE)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 11/883,673

(22) PCT Filed: Jan. 21, 2006
(86) PCT No.: PCT/EP2006/000539

§ 371 Date: Aug. 2, 2007

(30) Foreign Application Priority Data
Feb. 4, 2005 (DE) 10 2005 005 467.6

(51) Int. Cl. B01D 39/20

(52) U.S. Cl. 428/222; 55/523

(57) ABSTRACT

Composites comprising at least a hollow fiber for the gas- or liquid-transporting ceramic material whose outer surface is in contact with the outer surface of the same or another hollow fiber and the contact sites are joined by sintering are described.

Additional composites include at least one hollow fiber from gas- or liquid-transporting ceramic material and at least a connection element for feed or discharge of fluids on at least one of the ends, in which hollow fibers are joined to the connection element by sintering.

The composites can be used for recovery of gases from gas mixtures.

### RELATED APPLICATIONS

The present application is the U.S. National Phase of PCT Application PCT/EP2006/000539, filed 21 Jan. 2006, claiming priority to German Patent Application No. 10 2005 005 467.6, filed 4 Feb. 2005.

### BACKGROUND

### State of the Art

The present invention concerns composites from ceramic hollow fibers, which are particularly suited for liquid and gas filtrations, for example, high temperature applications, like gas separations, except for oxygen separation, and which have particularly high stability.

Ceramic hollow fibers are known per se. Their production is described for example in U.S. Pat. No. 4,222,977 or in U.S. Pat. No. 5,707,584.

S. Liu, X. Tan, K. Li and R. Hughes report in J. Mem. Sci. 193 (2001), 249-260 on the production of ceramic membranes and hollow fibers from SrCe_{0.95}Yb_{0.05}O_{2.975}. Gas-tight hollow fibers were produced and their mechanical properties as well as their microstructure investigated.

J. Luyten reports in CIMTEC 2002, pp. 249-258 on production of ceramic perovskite fibers. Hollow fibers from La_{0.6}Sr_{0.4}Co_{0.8}Fe_{0.2}O_{3-δ} are described.

Membranes from ceramic materials can be produced porous or gas-tight, while selected ceramic materials, on the other hand, have gas permeability and can therefore be used for separation of gases from gas mixtures. Possible applications of such ceramics include high-temperature applications, like gas separation or also innovative membrane reactors.

The known methods for producing ceramic hollow fibers include a spinning process in which elastic green fibers in a first step are produced from a spinnable mass containing precursors of the ceramic material and polymers. The polymer fraction is then burned at high temperatures and pure ceramic hollow fibers are formed.

A phase inversion process occurs during spinning and porous membranes are generally the result in the first step. These can also be burned tight by a controlled temperature increase.

The fibers produced in this way are comparatively stable mechanically; however, they naturally exhibit the brittleness and fracture sensitivity typical of ceramic materials.

### SUMMARY OF THE INVENTION

It has now surprisingly been found that ceramic hollow fibers from selected materials can be combined with other molded particles or with other ceramic hollow fibers to more complex structures and bonded by sintering. This can occur without using temporary adhesives. Structures with much higher stability are produced, whose handling, especially with respect to safety considerations, is substantially improved.

The present invention is based, among other things, on the surprising finding that precursors of selected ceramic materials when heated at the contact sites with other materials sinter together very efficiently without requiring the use of an auxiliary, like an adhesive or slip.

The technical problem underlying the present invention is to provide structures from one or more ceramic hollow fibers or from ceramic fibers with other molded articles, in which the structures are characterized by particularly high stability and improved handling.

Another technical problem of the present invention is to provide a method that is easy to perform for production of the stability-improved structures in which ordinary equipment for production of ceramic molded articles can be used.

### DETAILED DESCRIPTION

The present invention concerns a composite comprising at least one hollow fiber from a gas- or liquid-transporting ceramic material whose outer surface is in contact with the outer surface of the same hollow fiber or another hollow fiber of a gas- or liquid-transporting ceramic material and the contact sites are joined by sintering.

Another embodiment of the present invention concerns a composite comprised of at least one hollow fiber from gas- or liquid-transporting ceramic material and at least one connection element arranged on one, preferably on both end surfaces of the hollow fiber for feed or discharge of fluids, in which the hollow fiber is joined to the at least one connection element by sintering.

Such composites according to the invention are characterized by improved stability relative to the prior art with the thinnest possible walls and a high specific surface.

The hollow fiber used according to the invention can have any cross section, for example, angular, ellipsoidal, or especially circular cross sections.

Hollow fibers in the context of this description are understood to mean structures that have a hollow internal space and whose outer dimensions, i.e., diameter or linear dimensions, can be arbitrary.

The term hollow fibers in the context of this description, in addition to the conventional meaning of this term, is also understood to mean capillaries with outside diameter from 0.5 to 5 mm and tubes with outside diameter of more than 5 mm.

Preferred outside diameters or linear dimensions of the hollow fibers vary in the range up to 5 mm. Hollow fibers with outside diameters of less than 3 mm are used with particular preference.

Hollow fibers in the context of this description are understood to mean hollow fibers with any lengths. Examples of this are hollow monofilaments or hollow staple fibers (monofilaments of finite length).

The composites according to the invention can represent arbitrary combinations of ceramic hollow fibers from gas- or liquid-transporting ceramic materials.

For example, the following composites can be produced:
several hollow fibers in longitudinal contact arranged in one plane
several hollow fibers braided or twisted with each other
several hollow fibers combined to a monolith (multichannel element made of hollow fibers).
   Because of the flexibility and elasticity of the green fibers, in which the percentage of ceramic (precursor) phase is not too high, many additional geometries are possible. The fibers retain their original functionality because of this structuring, i.e., their liquid or gas permeability.

Such composites can then be combined further to membrane modules. These systems are particularly suited for use at high temperature applications, for example, in gas separation or also as components of membrane reactors.

The hollow fibers used according to the invention can be produced by a known spinning process. A solution spinning process, like dry or wet spinning, or a melt spinning process can be involved. The mass being spun includes a spinnable polymer in addition to the finely divided ceramic material or its precursor.

The content of spinnable polymer in the mass being spun can vary over a wide range but typically is 2 to 30 wt %, preferably 5 to 10 wt %, referred to the total mass or spinning solution being spun.

The content of finely divided ceramic material or its precursor in the mass being spun can also vary over a wide range but typically is 20 to 90 wt %, preferably 40 to 60 wt %, referred to the total mass or spinning solution being spun.

The content of solvent in the mass being spun can vary over a wide range but typically is 10 to 80 wt %, preferably 35 to 45 wt %, referred to the total spinning solution.

The type and amount of spinnable polymer and finely divided ceramic material or its precursor are preferably chosen so that still spinnable masses are obtained in which the content of spinnable polymer is chosen as low as possible.

Spinning occurs by extrusion of the spinning solution or the heated and plasticized spinning mass through an annular nozzle, followed by cooling in air and/or introduction to a precipitation bath, which contains a nonsolvent for the polymer used in the spinning mass. The obtained green hollow fibers can then be subjected to further processing steps, for example, cutting to stable fibers or winding for intermediate storage.

In a processing step connected with forming, the obtained green hollow fibers are combined to the desired composite. This can be a combination of several identical or different green hollow fibers or a combination of one or more green hollow fibers with at least one connection element arranged on their surface or surfaces for feed or discharge of fluids, like liquids or especially gases.

The combination of green hollow fibers can occur by any techniques. Examples of these are manual combination, like placing hollow fibers running parallel to each other in contact with each other, but also textile techniques, like production of warp-knit, woven fabrics, lays, knitted fabrics, braided or twisted structures.

After production of the composite of green hollow fiber(s), the polymer is removed in known fashion by heat treatment. This step also includes formation of a ceramic from the precursor for the ceramic material and/or sintering together the finally divided ceramic articles. By selection of the treatment parameters, like temperature program and atmosphere, the properties of the forming ceramic can be controlled in a manner known to one skilled in the art.

The hollow fibers combined to composites according to the invention consist of gas- or liquid-transporting ceramic material. Such materials are known per se. The ceramic material used according to the invention is a gas- or liquid-transporting ceramic material. It can be an ordinary ceramic or oxide ceramic, like Al₂O₃, ZrO₂, TiO₂ or also SiC. In addition, functional ceramics like perovskite or other liquid- or gas-conducting ceramics can also be used. However, oxygen-conducting or transporting ceramics are excepted from the object of this teaching.

Macroscopic mixtures of different ceramics can naturally also be used, for example Al₂O₃ particles combined with TiO₂ particles. In addition, atomic mixtures can also be used, i.e., certain crystal lattice sites of a ceramic are replaced by other atoms. The invention therefore also concerns doped ceramics, for example Y-doped zirconium oxide.

Composites, i.e., combinations of ceramics, for example metals or combinations of ceramics with ceramic or metal coatings, for example spinel nanoparticles, which are coated on ceramics to adjust the pore size, or hydrogen-conducting Pd alloys, which are coated on the ceramics could also be used according to the invention.

The ceramics used according to the invention can be porous, i.e., especially micro- or nanoporous, or gas-tight.

The invention also concerns a method for production of the aforementioned composites comprising the measures:
i) Production of a green hollow fiber by extrusion of a composition containing, in addition to a polymer, a ceramic, especially oxide ceramic, or a precursor for a ceramic, through an annular nozzle in known fashion,
ii) Generation of a green composite from one or more green hollow fibers produced in step i) by production of contacts between the outer surface or surfaces of the green hollow fiber or fibers and
iii) Heat treatment of the green composite produced in step ii) in order to eliminate the polymer, optionally to form the ceramic, especially oxide ceramic and to join the hollow fiber(s) at the contact sites by sintering.

In another embodiment the invention concerns a method for production of the aforementioned composite, comprising the measures:
i) Production of a green hollow fiber by extrusion of a composition containing, in addition to a polymer, a ceramic, especially oxide ceramic, or a precursor for a ceramic, through an annular nozzle in known fashion,
iv) Generation of a green composite from one or more green hollow fibers produced in step i) and at least one connection element for feed or discharge of fluids on at least one end surface of the green hollow fibers, and
v) Heat treatment of the green composite produced in step iv) in order to eliminate the polymer, optionally to form the ceramic, especially oxide ceramic and to join the hollow fibers(s) and the at least one connection element at the contact sites by sintering.

In the two aforementioned variants of the present invention the employed ceramic is present in the desired structure and crystallinity before spinning. However, it can also be prescribed to carry out the extrusion step (step i) with ceramic precursors and to form the ceramic only during heat treatment (step iii or v).

The outside diameter (Dₐ) and inside diameter (Dᵢ) of the hollow fibers produced according to the invention can vary over a wide range. Example of Dₐ are 0.1 to 5 mm, especially 0.5 to 3 mm. Example of Dᵢ are 0.01 to 4.5 mm, especially 0.4 to 2.8 mm.

Hollow fibers in the form of monofilaments are produced with particular preference, whose cross-sectional shape is round, oval or n-gonal, in which n is greater than or equal to 3. In non-round fiber cross sections Dₐ is the largest dimension of the outer cross section and Dᵢ the largest dimension of the inner cross section.

The polymers known for production of ceramic fibers can be used to produce the hollow fibers used according to the invention. In principle, any polymers spinnable from the melt or solution can be involved. Examples of these are polyesters, polyamides, polysulfones, polyarylene sulfides, polyether sulfones and cellulose.

The ceramic masses known from production of ceramic fibers, which have productivity for the gas or liquid being separated or their precursors can be used to produce the hollow fibers according to the invention. Examples of gas- or liquid-transporting masses were already mentioned above. The precursors of the ceramic masses can be mixtures that are present during shaping, are still noncrystalline or partially crystalline, and are only converted to the desired crystal structure during sintering of the forms.

After compression of the spinning mass through a spinning nozzle, the green hollow fibers are introduced to a precipitation bath or a cooling bath, preferably a water bath, and then wound. The winding speed is usually 1 to 100 m per minute, preferably 5 to 20 m/min.

The green hollow fibers can contain additional auxiliaries in addition to the ceramic materials or their precursors and the polymers. Examples are stabilizers for the slip, like polyvinyl alcohol, polyethylene glycol, surfactants, ethylenediaminetetraacetic acid or citric acid, additives to adjust the viscosity of the slip, polyvinylpyrrolidone or salts as sources for cations for doping of the ceramic.

After production of the green hollow fibers they are combined in the aforementioned manner to composites, i.e., with other green hollow fibers and/or with feeds and discharges for fluids. The feeds and discharges can be molded articles from metals, ceramics or precursors of ceramics.

The green composites are then tempered. This can occur in air or in a protective gas atmosphere. The temperature program and sintering times are adjusted to the individual case. The parameters to be adjusted are known to one skilled in the art. The tempering step leads to compaction of the green precursor. On the one hand, the polymer disappears and on the other hand the pores of the forming ceramic are closed by the appropriately selected tempering conditions so that gas-tight composites can also be obtained if necessary.

The composites according to the invention can be used in all industrial areas.

The invention also concerns the use of the composites described above to recover certain gases or liquids from gas or liquid mixtures. The following examples explain the invention without limiting it. Percentages refer to weight, unless otherwise stated.

### EXAMPLE 1

### Preparation of a Green Hollow Fiber

A ceramic powder of the composition Al₂O₃ was mixed with polysulfone (UDEL P-3500, Solvay) and 1-methyl-2-pyrrolidone (NMP) (≧99.0%, Merck) to a slip. This was then homogenized in a ball mill.

The spinning mass obtained in this way was spun through a hollow core nozzle with an outside diameter (Dₐ) of 1.7 mm and an inside diameter (Dᵢ) of 1.2 mm. For this purpose the spinning mass was filled into a pressure vessel and pressurized with nitrogen. After opening of the cock on the pressure vessel the spinning mass flowed out and was forced through the hollow core nozzle. The green fiber strand was passed through a precipitation-water bath and then dried.

### EXAMPLE 2

### Preparation of a Composite from Ceramic Hollow Fibers

Several hollow fibers produced according to example 1 were arranged parallel to each other so that they were in contact along their outer shell.

This composite of green hollow fibers was sintered for 2 hours at 1500° C. suspended in a furnace.

After sintering, a coherent composite of individual hollow fibers was obtained. The individual hollow fibers had a length of 30-35 cm, as well as diameter Dₐ of 0.8-0.9 mm and Dᵢ of 0.5-0.6 mm.

### EXAMPLE 3

### Preparation of Another Composite from Ceramic Hollow Fibers

Several of the hollow fibers prepared according to example 1 were manually braided with each other and treated thermally according to the method described in example 2.

After sintering a coherent mesh of individual hollow fibers was obtained.

### EXAMPLE 4

### Preparation of Another Composite from Ceramic Hollow Fibers

Several of the hollow fibers prepared according to example 1 were combined with each other manually on the surface of a rod-like mold so that they were arranged as a tubular multichannel element whose individual capillaries were hollow fibers running parallel to each other.

The obtained green multichannel element was heat-treated according to the method described in example 2.

The internal space of the multichannel element was empty after sintering and removal of the rod-like mold. A multichannel element of hollow fibers running parallel to each other and sintered together was obtained.

### EXAMPLE 5

### Preparation of Another Composite from Ceramic Hollow Fibers

Several hollow fibers prepared according to example 1 were wound along the surface of a rod-like mold so that they formed a helical multichannel element whose individual capillaries touched each other along the coil.

The obtained green multichannel element was heat treated according to the method described in example 2.

The internal space of multichannel elements was empty after sintering and removal of the rod-like mold. A multichannel element of hollow fibers sintered together running parallel to each other helically was obtained.

### EXAMPLE 6

### Preparation of a Composite from Ceramic Hollow Fibers with Connection Elements for Feed and Discharge of Gases

Several hollow fibers prepared according to example 1 were combined with each other manually so that they were arranged in the form of a multichannel element whose individual capillaries were hollow fibers running parallel to each other. The internal space of the multichannel element was completely filled with hollow fibers when viewed in cross section.

On both ends of the green multichannel element metal connection elements for feed discharge of gases were mounted.

The obtained green composite was heat treated according to the method described in example 2.

After sintering a multichannel element of hollow fibers sintered together running parallel to each other was obtained, which had gas permeability. This multichannel element was firmly connected on both ends with the metal connection elements by sintering.

1-23. (canceled)

24. A hollow fiber membrane composite comprising at least one hollow fiber membrane comprising gas-permeable or liquid-permeable ceramic material, other than oxygen-permeable ceramic materials, the gas-permeable or liquid-permeable ceramic material having an outer surface, the outer surface being in contact with the outer surface of the same hollow fiber membrane or another hollow fiber membrane so as to have contact sites, the contact sites being joined by sintering.

25. A hollow fiber membrane composite according to claim 24, comprising several hollow fibers formed from gas-permeable or liquid-permeable ceramic material braided or twisted with each other.

26. A hollow fiber membrane composite according to claim 24, comprising at least two hollow fibers from gas-permeable or liquid-permeable ceramic material running parallel with each other, each having outer surfaces in contact with the outer surfaces of the other at least partially along a length thereof and which are joined at contact sites by sintering.

27. A hollow fiber membrane composite according to claim 26, wherein the membrane comprises several hollow fibers running generally parallel to each other arranged in the form of a tubular multichannel element, the outer surfaces of the hollow fibers being in contact at least partially along their length and which are joined points of contact by sintering.

28. A hollow fiber membrane composite according to claim 27, wherein the hollow fibers form the shell of a tubular multichannel element having an internal space is hollow or has a rod-like reinforcement material.

29. A hollow fiber membrane composite according to claim 28, wherein the hollow fibers run along the inside of a tube made of gas-tight material.

30. A hollow fiber membrane composite according to claim 28, wherein the hollow internal space of the tubular multichannel element has a catalyst.

31. A hollow fiber membrane composite according to claim 24, wherein the hollow fiber membrane comprises one or more hollow fibers that are woven or knitted to each other.

32. A hollow fiber membrane according to claim 1, characterized by the fact that the gas-permeable or liquid-permeable ceramic material is an oxide ceramic.

33. A composite comprising at least one hollow fiber membrane from gas-permeable or liquid-permeable ceramic material and a connection element on both ends thereof for feed or discharge of fluids, in which the at least one hollow fiber membrane is connected to the connection elements by sintering.

34. The composite according to claim 33, wherein the at least one hollow fiber membrane comprises at least two hollow fibers running parallel to each other, said hollow fibers having outer shells which are in contact at least partially along lengths thereof and wherein the hollow fibers are joined at contact sites by sintering.

35. The composite according to claim 34, wherein the at least one hollow fiber member comprises several hollow fibers running parallel to each other in the form of a tubular multichannel element, the several hollow fibers having outer shells which are in contact at least partially along their length and are joined by sintering at contact sites.

36. The composite according to claim 35, wherein the hollow fibers form a shell of a tubular multichannel element whose internal space is hollow or has a rod-like reinforcement material.

37. The composite according to claim 34, further comprising a tube made of gas tight materials and wherein the hollow fibers run along the inside of the tube made of gas-tight material.

38. The composite according to claim 33, wherein the gas-permeable or liquid-permeable ceramic materials are oxide ceramic.

39. The composite according to claim 38, wherein the oxide ceramic has a perovskite structure or a brownmillerite structure.

40. A method for producing a composite having at least one hollow fiber membrane comprising gas-permeable or liquid-permeable ceramic material, other than oxygen-permeable ceramic materials, the gas-permeable or liquid-permeable ceramic material having an outer surface, the outer surface being in contact with the outer surface of the same hollow fiber membrane or another hollow fiber membrane so as to have contact sites, the contact sites being joined by sintering, the method comprising:
a) preparing a green hollow fiber by extrusion of a composition containing a ceramic, especially oxide ceramic, or a precursor for a ceramic, in addition to a polymer, through an annular nozzle in known fashion;
b) generation of a green composite from one or more of the green hollow fibers produced in step a) by production of contacts between the outer surface or surfaces of the green hollow fiber or fibers; and
c) heat treatment of the green composite produced in step b) in order to eliminate the polymer and to form a contact between the ceramic hollow fibers as well as optionally the ceramic, especially oxide ceramic.

41. The method according to claim 40, wherein the method comprising extruding the composition according to a dry spinning method, a wet spinning method or a melt spinning method.

42. The method according to claim 40, wherein preparing the composite occurs by braiding, twisting, weaving, knitting, warp knitting of the green hollow fiber(s) or by laying the green hollow fibers running parallel to each other.

43. The method according to claim 42, wherein the green hollow fibers are arranged around rod-like reinforcement element or a tube.

44. The method according to claim 40, characterized by the fact that heat treatment of the green composite produced in step b) occurs at temperatures that range from 900 to 1600° C.

45. A method for producing a composite comprising at least one hollow fiber membrane from gas-permeable or liquid-permeable ceramic material and a connection element on both ends thereof for feed or discharge of fluids, in which the at least one hollow fiber membrane is connected to the connection elements by sintering, the method comprising:
a) preparing green hollow fiber by extrusion of a composition containing a ceramic, especially oxide ceramic, or a precursor for a ceramic, in addition to a polymer, through an annular nozzle in known fashion;
b) producing a green composite from one or more of the green hollow fibers produced in step a) and at least two connection elements for feed or discharge of fluids on both ends of the green hollow fibers; and
c) heat treating the green composite produced in step b) to eliminate the polymer and to produce contact between the ceramic hollow fibers and the connection elements as well as optionally the ceramic, especially oxide ceramic.

46. A method for recovering gases from gas mixtures or for liquid filtration, the method comprising passing a fluid through a hollow fiber membrane composite comprising at least one hollow fiber membrane comprising gas-permeable or liquid-permeable ceramic material, other than oxygen-permeable ceramic materials, the gas-permeable or liquid-permeable ceramic material having an outer surface, the outer surface being in contact with the outer surface of the same hollow fiber membrane or another hollow fiber membrane so as to have contact sites, the contact sites being joined by sintering.
